(19) United States
(12) Patent Application Publication
(10) Pub. No.: US 2010/0171244 A1
(43) Pub. Date: Jul. 8, 2010

(54) REACTION INJECTION MOLDING

(76) Inventors: Randy Hire, Fort Wayne, IN (US); Tim Pape, Fort Wayne, IN (US); Toai Ngo, Fort Wayne, IN (US); Scott Pflughoeft, Auburn, IN (US)

Correspondence Address: TAYLOR & AUST, P.C., P.O. Box 560, 142. S Main Street, Avilla, IN, 46710, US

(21) Appl. No.: 12/683,892

(22) Filed: Jan. 7, 2010

Related U.S. Application Data
(60) Provisional application No. 61/142,980, filed on Jan. 7, 2009.

(51) Int. Cl. B29C 45/57; B29C 45/00

(52) U.S. Cl. 264/570; 425/542

(57) ABSTRACT

A system for molding a part including a first surface and a second surface opposing the first surface, the system includes: a pressure supply arrangement; and a Reaction Injection Molding (RIM) arrangement including a pin plate assembly and a mold defining a mold cavity, the RIM arrangement configured for supplying a bi-component liquid mixture to the mold cavity in which the bi-component liquid mixture chemically reacts and thereby forms a thermoset polymer, the pin plate assembly coupled with the pressure supply arrangement and the mold, the pressure supply arrangement configured for supplying an inert gas to the mold cavity via the pin plate assembly and thereby for one of reducing and eliminating a formation of a sink mark on the first surface of the part.

### CROSS REFERENCE TO RELATED APPLICATIONS

This is a non-provisional application based upon U.S. provisional patent application Ser. No. 61/142,980, entitled “REACTION INJECTION MOLDING”, filed Jan. 7, 2009, which is incorporated herein by reference.

### BACKGROUND OF THE INVENTION

1. Field of the Invention

The present invention relates to reaction injection molding.

2. Description of the Related Art

In polymers with a high shrink ratio, especially through the thickness of the part, areas of greater thickness will shrink more than areas with a relatively smaller thickness. When left unconstrained in the mold cavity of a mold, the shrinkage tends to be very noticeable on the show-surface of the molded part. Sink marks will occur at the thicker sections.

What is needed in the art is a reaction injection molding system that reduces, eliminates, or prevents sink marks from forming on the show-surface of the molded part.

### SUMMARY OF THE INVENTION

The present invention provides a reaction injection molding system that reduces, eliminates, or prevents sink marks from forming on the show-surface of the molded part.

The invention in one form is directed to a system for molding a part including a first surface and a second surface opposing the first surface, the system including: a pressure supply arrangement; and a Reaction Injection Molding (RIM) arrangement including a pin plate assembly and a mold defining a mold cavity, the RIM arrangement configured for supplying a bi-component liquid mixture to the mold cavity in which the bi-component liquid mixture chemically reacts and thereby forms a thermoset polymer, the pin plate assembly coupled with the pressure supply arrangement and the mold, the pressure supply arrangement configured for supplying an inert gas to the mold cavity via the pin plate assembly and thereby for one of reducing and eliminating a formation of a sink mark on the first surface of the part.

The invention in another form is directed to a method for molding a part including a first surface and a second surface opposing the first surface, the method including the steps of: providing a pressure supply arrangement and a Reaction Injection Molding (RIM) arrangement including a pin plate assembly and a mold defining a mold cavity, the pin plate assembly coupled with the pressure supply arrangement and the mold; supplying a bi-component liquid mixture to the mold cavity using the RIM arrangement; reacting chemically the bi-component liquid mixture and thereby forming a thermoset polymer; and supplying, using the pressure supply arrangement, an inert gas to the mold cavity via the pin plate assembly and thereby one of reducing and eliminating a formation of a sink mark on the first surface of the part.

An advantage of the present invention is that read-through of features occurring on opposite sides of a molded part can be eliminated, read-through being a condition where features of differing masses cause deformation on the opposite surface and which would otherwise require additional processing to avoid failing to meet customer standards.

Another advantage of the present invention is that features of differing masses can be molded of the same material, for example, so as to form an overall part (i.e., a radiator door), thus eliminating re-work and secondary molding and bonding processes.

Yet another advantage of the present invention is that tooling and processing costs are reduced, yielding a higher quality part at a lower production cost.

Yet another advantage of the present invention is that it involves Reaction Injection Molding.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of an embodiment of the Pressure-Over-Polymer Reaction Injection Molding system according to the present invention;

FIG. 2 is a perspective view of a molded part molded using the system according to the present invention;

FIG. 3 is a plan view of the show-surface of the molded part of FIG. 2;

FIG. 4 is a top view of the Reaction Injection Molding arrangement according to the present invention;

FIG. 5 is a cross-sectional view of the Reaction Injection Molding arrangement of FIG. 4; and

FIG. 6 is a detail view of FIG. 5 focusing on a portion of one pin of the pin plate assembly according to the present invention.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF THE INVENTION

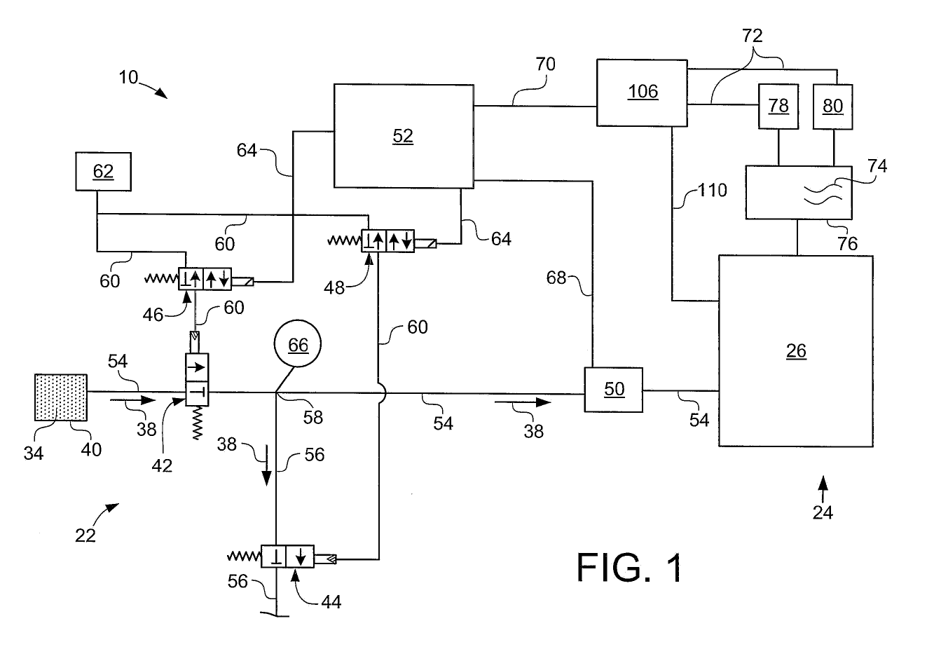

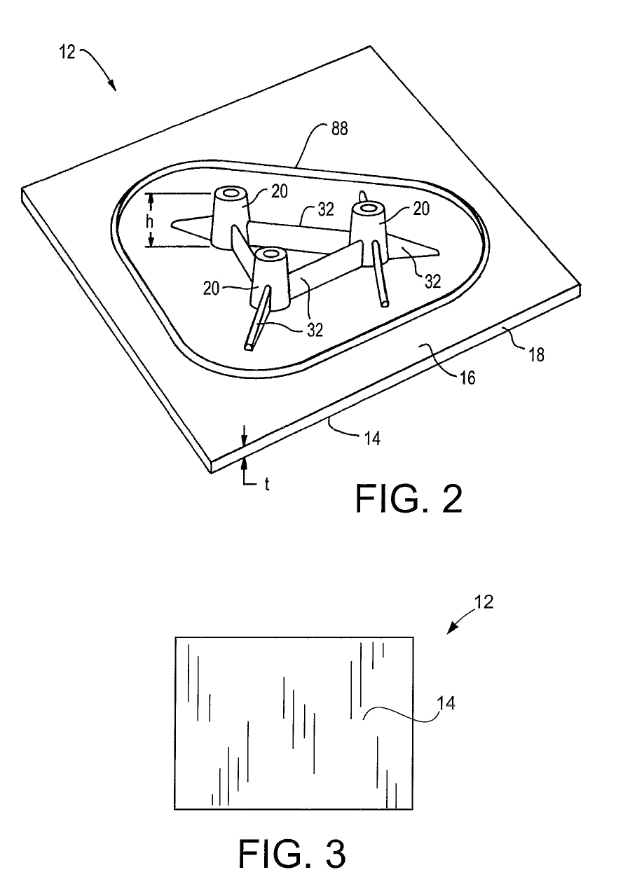

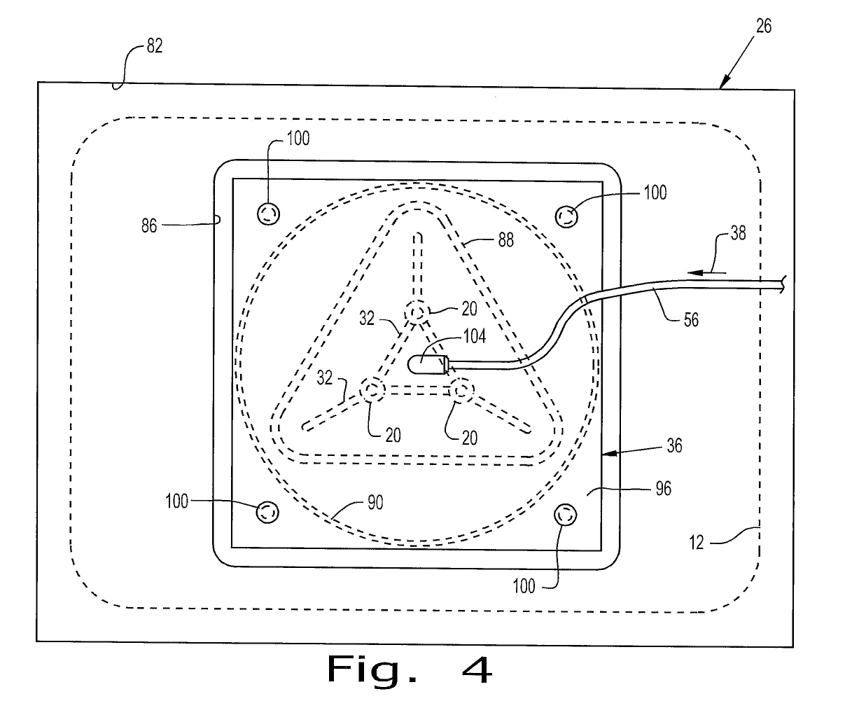

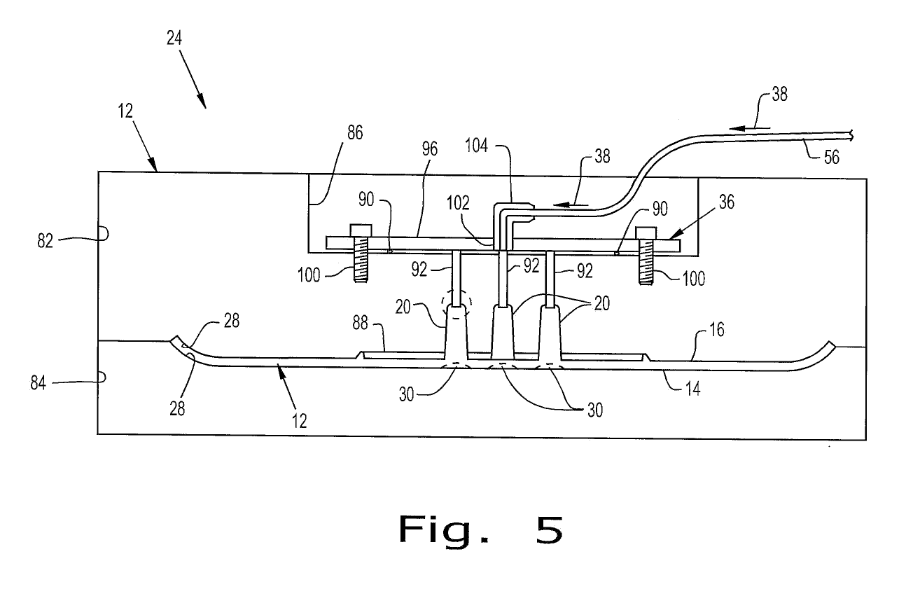

Referring now to the drawings, and more particularly to FIGS. 1-3, there is shown an embodiment of an inventive Pressure-Over-Polymer Reaction Injection Molding (POP RIM) system 10 for molding a part 12 including a first surface 14 and a second surface 16 opposing first surface 14. FIGS. 2 and 3 show schematically part 12 molded according to the present invention, the part 12 having a wall 18, a boss 20 extending from wall 18, first surface 14 of wall 18, and second surface 16 of wall 18, first surface 14 being the show-surface 14 of part 12 and also being referred to as the A-surface 14, second surface 16 also being referred to as the B-surface 16. Molded part 12 can, for example, be a radiator door for an agricultural combine, a fender, a body panel, or the like. System 10 generally includes a pressure supply arrangement 22 (pressure supply arrangement 22 can also be referred to as a pressure control unit 22) and a Reaction Injection Molding (RIM) arrangement 24 including a mold 26 defining a mold cavity 28. (See also FIGS. 4-6).

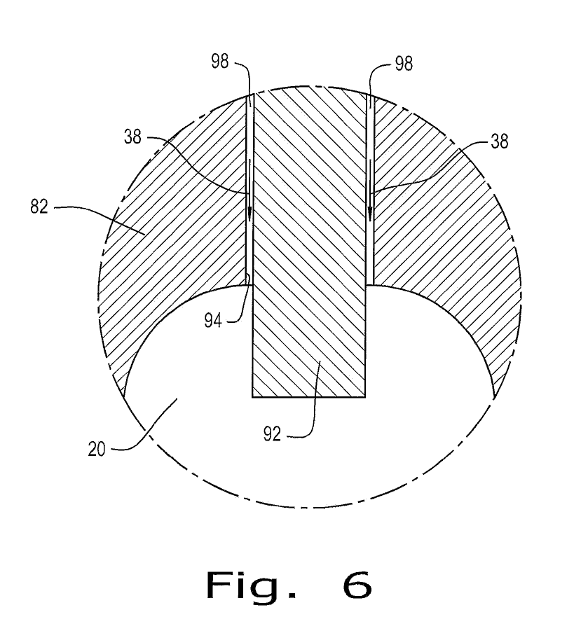

FIG. 2 shows molded part 12, which has been molded according to the present invention. As indicated, part 12 includes A-surface 14 and B-surface 16. A-surface 14 (the show-surface 14) is the external surface when molded part 12 is incorporated into, for example, an agricultural combine, and B-surface 16 is the hidden surface or internal surface. B-surface 16 is on the opposite side of wall 18 relative to A-surface 14. Part 12 also includes wall 18 and three bosses 20; a description of one boss 20 serves as the description of the other bosses 20. Boss 20 has a greater mass than the wall 18. Wall 18 has a thickness t which is less than the height h of boss 20. Boss 20, for example, can be a generally cylindrical element projecting from B-surface 16 of wall 18. The portion of wall 18 without boss 20 may, for example, have a thickness t of three to four millimeters, whereas boss 20, for example, may have a diameter of three-fourths of an inch and a height h projecting from wall 18 of one inch. Boss 20 may have a hollow core running therethrough, may have a solid core, or may have a solid core extending through most of the longitudinal extent of boss 20 and a hollow portion near the distal end of boss 20 (as indicated in FIGS. 5 and 6). Without using POP RIM of the present invention, A-surface 14 of molded part 12 can include sink marks 30 corresponding to each of bosses 20 formed on B-surface 16 of part 12. These sink marks 30 are shown as dashed lines in FIG. 5. If POP RIM is not used, then three sink marks (generally round depressions) on A-surface 14 will be formed as the points of a triangle (and thus in a triangular configuration) corresponding to the three bosses 20 on B-surface 16. FIG. 5 shows three sink marks 30 corresponding to the three bosses 20; sink marks 30 are shown in broken lines because they formed during the molding process but were eliminated by the end of the molding process (as indicated by the straight solid black line forming A-surface 14 of part 12 in FIG. 5). On the other hand, POP RIM of the present invention reduces, eliminates, or prevents sink marks from being formed on A-surface 14 opposite bosses 18 and any ribs. FIG. 3 shows A-surface 14 of molded part 12 of FIG. 2, A-surface 14 having no sink marks. For the sake of clarity, FIG. 5 does not show ribs 32 shown in FIGS. 2 and 4. Further, while FIG. 4 does not show the same rib configuration as in FIG. 2, molded parts 12 in FIGS. 2, 4, and 5 have the same reference number 12. The result of the process of the present invention is a molded part 12 that does not show, or at least shows reduced, sink marks 30 on A-surface 14. To accomplish this result, the present invention uses, during molding, pressure applied to B-surface 16 of the curing part 12 to force A-surface 14 of part 12 to conform to the geometry of the mold's cavity 28. Any way of providing adequate pressure is contemplated as being within the scope of the present invention, whether the pressure is provided mechanically or by a fluid, such as a gas. Thus, POP RIM is a method of eliminating or improving sink marks or thermal shrink to A-surface 14 of a thermoform “molded polymer part” 12 by applying pressure to B-surface 16 (opposite) side of part 12.

Pressure supply arrangement 22 is configured for supplying an inert gas 34 to mold cavity 28 of mold 26 via pin plate assembly 36 and thereby for reducing, eliminating, or preventing a formation of a sink mark on the first surface 14 of part 12. Inert gas 34 can be, for example, Nitrogen. Arrow 38 shows the direction of travel of the Nitrogen 34. Pressure supply arrangement 22 is configured for supplying Nitrogen 34 to mold cavity via pin plate assembly 36 under an increasing pressure until the part 12 is formed.

Pressure supply arrangement 22 includes a fluid source 40, a first high pressure valve 42 (which can be referred to as inlet valve 42 or pressure control valve 42), a second high pressure valve 44 (which can be referred to as dump valve 44 or vent valve 44), a first solenoid valve 46 operatively associated with inlet valve 42, a second solenoid valve 48 operatively associated with dump valve 44, a pressure sensor 50, and a controller 52 which is operatively coupled with first solenoid valve 46, second solenoid valve 48, pressure sensor 50, and RIM arrangement 24. Pressure supply arrangement 22 further includes a first gas line 54 and a second gas line 56 intersecting said first gas line 54 to form an intersection 58, inlet valve 42 and dump valve 44 being in fluid communication with one another, pin plate assembly 36, and mold cavity 28 via first and second gas lines 54, 56. Pressure supply arrangement 22 is configured for preventing the pressure of the inert gas 34 from overshooting a plurality of set-point values in mold cavity 28.

Fluid source 40 can be any system that supplies a fluid, such as Nitrogen gas 34, with enough pressure to keep or move the first surface 14 of the forming part 12 in mold cavity 28 against the surface of mold 28. Fluid source 40 can be a Nitrogen generator which generates Nitrogen from ambient air. Alternatively, fluid source 40 can be bottled Nitrogen. If necessary, a pump (not shown) can be used to sufficiently pressurize the fluid (i.e., Nitrogen) supplied to mold 26 for providing pressure to second surface 16 of part 12 being formed in mold 26. Alternatively, fluid source 40 (which can also be referred to as a fluid supply 40) can be a tank filled with Nitrogen 34 and thus be a Nitrogen tank 40. Such a Nitrogen tank 40 can store the Nitrogen 34 under high pressure, that pressure being equal to or exceeding the maximum Nitrogen pressure needed in mold cavity 28. A pressure regulator (not shown) can be provided on such a Nitrogen tank 40, the pressure regulator being set such that Nitrogen 34 exits pressure regulator at a pressure which is equal to or exceeds the maximum Nitrogen pressure needed in mold cavity 28. Nitrogen 34 can be stored in Nitrogen tank 40 at 2,200 pounds per square inch gauge (psig), for example. Nitrogen 34 flows downstream via gas line 54 to inlet valve 42.

Inlet valve 42 is connected to first gas line 54. As shown in FIG. 1, inlet valve 42 is positioned upstream from intersection 58. Inlet valve 42 serves to control the Nitrogen flow from Nitrogen tank 40 to mold 26; inlet valve 42 regulates the flow and thus the pressure to the downstream side of inlet valve 42 (and thus to dump valve 44, sensor 50, and mold 26). Nitrogen 34 leaves Nitrogen holding tank 40 at a pressure set by the pressure regulator, that pressure being equal to or greater than what will ultimately be needed in mold cavity 28. The Nitrogen proceeds from tank 40 downstream to inlet valve 42, which allows only so much Nitrogen to flow through itself so as to present a reduced pressure initially to mold cavity 28. Over time, inlet valve 42 allows enough Nitrogen through itself to build the pressure up in mold cavity 28 to the maximum level desired or needed in mold cavity 28. The opening and closing of inlet valve 42 is controlled by controller 52 (which can also be referred to as a computer 52). Inlet valve 42 is controlled by the computer set-points programmed into controller 52; the computer set-points are time and pressure. Inlet valve 42 can be a three-way valve (a three-port valve). Inlet valve 42 can have a home position which is in the closed position and an open position allowing Nitrogen to proceed downstream from inlet valve 42. In the closed position, Nitrogen is blocked from proceeding downstream through inlet valve 42. Air regulated by solenoid valve 46 can be used to activate inlet valve 42 and to thereby move inlet valve 42 from the closed position to the open position; a spring (not shown) can be used to return inlet valve 42 to the home (closed) position when solenoid valve 46 no longer supplies air pressure to inlet valve 42. Thus, inlet valve 42 can be a pneumatically activated valve and can be assigned a respective solenoid valve 46, the air supply to inlet valve 42 from an air source 62 (i.e., an air compressor 62) being controlled by solenoid valve 46 via air supply line 60. Inlet valve 42 can be a Mini-Hippo piston air-operated valve which requires 50 to 90 psi air pressure, made by High Pressure Equipment Company of Erie, Pa.

Dump valve 44 is connected to second gas line 56, dump valve 44 being downstream of inlet valve 42. First gas line 54 (which can be referred to as a Nitrogen supply line 54) from inlet valve 42, as indicated above, can be intersected by second gas line 56 extending to dump valve 44. Dump valve 44 serves as a fluid (i.e., Nitrogen gas 34) release mechanism to ensure that the amount of Nitrogen supplied to mold cavity 28 via inlet valve 42 does not overshoot the pressure set-points (the desired pressure in mold cavity 28). Thus, if Nitrogen pressure in mold cavity 28 (as sensed by sensor 50) overshoots any of the pressure set-points, then controller 52 can trigger second solenoid valve 48 to open dump valve 44 to release/vent enough Nitrogen to reduce pressure in mold cavity 28 to the set-point valve. The Nitrogen proceeding through dump valve 44 can be vented into the environment or into a receiving tank (not shown) via the portion of gas line 46 proceeding downstream from dump valve 44. Dump valve 44 can be a three-way valve (a three-port valve). Dump valve 44 can have a home position which is in the closed position and an open position allowing Nitrogen 34 to proceed downstream from dump valve 44. In the closed position, Nitrogen is blocked from proceeding downstream through dump valve 44. Air regulated by solenoid valve 48 can be used to activate dump valve 44 and to thereby move dump valve 44 from the closed position to the open position; a spring (not shown) can be used to return dump valve 44 to the home (closed) position when solenoid valve 48 no longer supplies air pressure to dump valve 44. Thus, dump valve 44 can be a pneumatically activated valve and can be assigned a respective solenoid valve 48, the air supply to dump valve 44 from an air source 62 (i.e., an air compressor 62) being controlled by solenoid valve 48 via air supply line 60. Dump valve 44 can be a Mini-Hippo piston air-operated valve which requires 50 to 90 psi air pressure, made by High Pressure Equipment Company of Erie, Pa.

First solenoid valve 46 is assigned to inlet valve 42. First solenoid valve 46 serves to regulate compressed air flowing to inlet valve 42 so as to activate (open) inlet valve 42. First solenoid valve 46 can include a spool which shuttles back and forth. First solenoid valve 46 receives air via air supply line 60 from air compressor 62. In the home position, first solenoid valve 46 is closed and thus blocks air (from air compressor 62) from flowing through first solenoid valve 46 downstream of first solenoid valve 46. When opened, first solenoid valve 46 can allow the air from air compressor 62 to travel downstream to inlet valve 42 via air supply line 60; in this open position, first solenoid valve 46 can be such that air can flow downstream and upstream of valve 46, depending upon the pressure balance. In one embodiment of the present invention, first solenoid valve 46 can be a pneumatic valve; 90 psi air pressure can be supplied to solenoid valve 46, which is activated by controller 52. Solenoid valve 46 can be controlled by controller 52 via a respective signal line 64. In order to deactivate inlet valve 42 (return inlet valve 42 to the closed position), solenoid valve 46 can be configured such that air in the air supply line 60 extending between solenoid valve 46 and inlet valve 42 is vented to the atmosphere by solenoid valve 46; such venting can occur by returning solenoid valve 46 to its home position. Solenoid valve 46 can be a three-way or a four-way valve. A spring (not shown) can be used to return solenoid valve 46 to the home (closed) position when solenoid valve 46 is deactivated.

Second solenoid valve 48 is assigned to dump valve 44. Second solenoid valve 48 serves to regulate compressed air flowing to dump valve 44 so as to activate (open) dump valve 44. Second solenoid valve 48 can include a spool which shuttles back and forth. Second solenoid valve 48 receives air via an air supply line 60 from an air compressor 62. In the home position, second solenoid valve 48 is closed and thus blocks air (from air compressor 62) from flowing through second solenoid valve 48 downstream of second solenoid valve 48. When opened, second solenoid valve 48 can allow the air from air compressor 62 to travel downstream to dump valve 44 via air supply line 60; in this open position, second solenoid valve 48 can be such that air can flow downstream and upstream of valve 48, depending upon the pressure balance. In one embodiment of the present invention, second solenoid valve 48 can be a pneumatic valve; 90 psi air pressure can be supplied to solenoid valve 48, which is activated by controller 52. Solenoid valve 48 can be controlled by controller 52 via a respective signal line 64. In order to deactivate dump valve 44 (return dump valve 44 to the closed position), solenoid valve 48 can be configured such that air in the air supply line 60 extending between solenoid valve 48 and dump valve 44 is vented to the atmosphere by solenoid valve 48; such venting can occur by returning solenoid valve 46 to its home position. Solenoid valve 48 can be a three-way or a four-way valve. A spring (not shown) can be used to return solenoid valve 48 to the home (closed) position when solenoid valve 48 is deactivated.

A pressure gauge 66 can be connected to first gas line 54 at intersection 58, as shown in FIG. 1. Pressure gauge 66 displays the pressure of the Nitrogen in first gas line 54 to the operator.

Pressure sensor 50 (which can also be referred to as a pressure transducer 50) is connected to first gas line 54 (the Nitrogen supply line 54). As shown in FIG. 1, sensor 50 can be positioned downstream from inlet valve 42, intersection 58, and dump valve 44. Alternatively, sensor 50 can be positioned anywhere in first gas line 54 between inlet valve 42 and mold 26 (i.e., at intersection 58). Pressure sensor 50 senses the actual pressure in first gas line 54. Thus, pressure sensor 50 is configured for determining an actual pressure in first gas line 54. The actual pressure measurement is then supplied via a signal line 68 to controller 52. Sensor 50 can be a pressure transducer made by Viatran. Sensor 50 can be a 0-10 volt DC pressure transducer.

Controller 52 (which can also be referred to as a programmable control 52) regulates the pressure of the Nitrogen supplied to mold 26 based on a desired pressure (the set-point pressure) and the actual pressure of the Nitrogen as measured by pressure sensor 50. Thus, controller 52 is configured for receiving the actual pressure from sensor 50 via signal line 64, for comparing the actual pressure to at least one set-point pressure (the desired pressure), and for selectively influencing inlet valve 42 and dump valve 44 (via signal lines 64 from controller 52 to solenoid valves 46, 48) dependent on the actual pressure so that Nitrogen is supplied to mold cavity 28 in accordance with the at least one set-point pressure (the desired pressure in the mold cavity 28). Controller 52 thus has settings for desired pressure in mold cavity 28 and controls actual pressure values based on those desired pressure settings. Signal lines (not shown) respectively can run from mold 26, container 76, and/or tanks 78, 80 to controller 52 so that controller 52 controls the activities of these structures. Alternatively, controller 52 can be subject to a higher-level controller 106 (controller 106 being a part of RIM arrangement 24). In this alternative (as shown in FIG. 1), controller 106 provides a signal via signal line 70 to controller 52 so that controller 52 starts its sequence relative to progressing through a time delay and also through one or more stages of pre-set pressures and times. Controller 106 can also provide output signals to tanks 78, 80 via signal lines 72 (such as to release the liquids in tanks 78, 80 to flow to container 76) and/or to mold 26 via signal line 110 (such as to selectively open and close mold 26); at the appropriate time (i.e., when the liquids are released from tanks 78, 80 to container 76, when mold 26 closes, and/or when material 74 is to be injected into mold cavity 28), controller 106 can provide a signal via line 70 to controller 52 to start its sequence of activities regarding providing Nitrogen to mold cavity 28. Optionally, controller 106 can also receive a signal from container 76 and/or mold 26 to signal that material 74 is being or has been injected into mold cavity 28; controller 106 can then signal to controller 52 to start its sequence of activities regarding providing Nitrogen to mold cavity 28. Controller 52 thus has soft inputs of delay time, as well as time and pressure regarding one or more stages (i.e., Nitrogen pressure may be desired to be at 100 psig for 10 seconds in mold cavity 28 in one particular stage). Controller has hard inputs from the press—more specifically, controller 106—and also from sensor 50. Optionally, air compressor 62 can be manually turned on by an operator and set at a desired air pressure level or can be turned on and/or set to provide a prescribed air pressure via an output signal (not shown) from controller 52.

RIM arrangement 24 includes container 76, mold 26 defining mold cavity 28 (mold cavity 28 is shown in FIG. 4), and a pin plate assembly 36. RIM arrangement 24 can also include two separate liquid holding tanks 78, 80 which respectively feed the two liquid components therein (i.e., A and B components or parts) to container 76, the liquid mixture 74 in the container 76 (which is thus a bi-component liquid mixture 74) then being supplied to mold cavity 28 of mold 26. Container 76 can thus be referred to as a mixer 76 or mixing head 76 containing liquid mixture 74 which is supplied to mold. Bi-component liquid mixture 74 can be a mixture of a monomer and a catalyst (which can be held separately in tanks 78 and 80). In mold cavity 28, the monomer and catalyst chemically react such that the thermoset polymer results. Stated another way, in mold cavity 28 liquid mixture 74 from container 76 reacts chemically to form a solid polymer and thus the molded part 12. In one example, liquid 74 in container 76 can be a thermoset resin such as a TELENE® resin which includes A and B parts (the two components of mixture 74). The A and B parts mix in container 76 and are then injected into mold cavity 28. The A and B parts can be in a 50/50 ratio relative to one another. In one embodiment, the TELENE® resin can include dicyclopentadiene (DCPD)(one component of the bi-component mixture 84, i.e., the B-component) and a catalyst Molybdenum (the other component of the bi-component mixture 74, i.e., the A-component). In mold 26, DCPD reacts with Molybdenum and polymerizes to form a solid polymer poly-dicyclopentadiene (poly-DCPD or PDCPD). In this example, then, the molded part 12 is made of poly-DCPD. RIM arrangement 24 is thus configured for supplying a bi-component liquid mixture 74 to mold cavity 28 in which bi-component liquid mixture 74 chemically reacts and thereby forms a thermoset polymer (the thermoset polymer forms the molded part 12). Reference character 12 is used herein to refer not only to the molded part (the part demolded from mold 26) but also to the part that is at least partially formed in mold 26 (partially solidified and polymerized but not completely so).

FIGS. 4, 5, and 6 show mold 26. Mold 26 includes first half 82 (which can also be referred to as a core half 82) and second half 84 (which can also be referred to as a cavity half 84). First half 82 defines a recess 86 in which pin plate assembly 36 is seated. First and second halves 82, 84 together define mold cavity 28 in which molded part 12 is formed. FIG. 4 shows the lead line from 12 touching a broken line; this broken line is part 12 but is more specifically the perimeter of part 12. FIG. 4 also shows three bosses 20, which can be referred to as a boss cluster. Further, bosses 20, seal 88 molded into part 12, O-ring seal 90, and part 12 are shown in broken lines, as they are not visible from the top view. FIG. 5 shows mold halves 82, 84, pin plate assembly 36, and the molded part 12. Part 12 is formed with a pressure seal 88 molded into B-surface 16 around the perimeter of the boss cluster.

Pin plate assembly 36 (shown in FIGS. 4 and 5) is coupled with pressure supply arrangement 22 and mold 26 of RIM arrangement 24. Pin plate assembly 36 includes a pin plate 96 and at least one pin 92 projecting from pin plate 96 (three such pins are shown in FIGS. 4 and 5). First half 82 of mold 26 includes an injection orifice 94 in which the at least one pin 92 runs therethrough, injection orifice 94 and the at least one pin 92 forming an annular clearance 98 therebetween of 0.0005 inches which is configured for injecting the inert gas into mold cavity 28. Stated another way, as shown in FIGS. 5 and 6, a tight clearance, such as 0.0005 inches, is formed between mold 28 and the circumferential surface of each pin 92 (three pins 92 are shown in FIG. 5 corresponding to the three bosses 20). More specifically, considering a cross-section taken through mold 26 and pin 92 in FIG. 5, a clearance 98 of 0.0005 inches is provided on each side of pin 92 (this is the case for each pin 92). Injection orifice 94 and the at least one pin 92 form annular clearance 98 and thereby together are configured for allowing any incursion of bi-component liquid mixture 74 into annular clearance 98 to be pushed out of annular clearance 98 when inert gas 34 is injected into mold cavity 28 via annular clearance 98. Mold 26 carries pin plate 96. Pin plate 96 is attached to mold 26 using a plurality of fasteners 100, such as bolts or screws. Pin plate 96 can be seated in recess 86 formed in mold 26. According to one embodiment of pins 92, each pin has a solid core. Each pin 92 extends from plate 96 to a corresponding boss 20. Plate 96 further includes a through-hole 102. A fluid supply member 104 (such as a fitting 104) connects fluid supply line 56 with plate 96. Thus, the fluid, such as Nitrogen 34, flows from line 56, through member 104, and through pin plate 96. A seal 90, such as an O-ring 90, is disposed between pin plate 96 and mold 26. Further, as shown in FIGS. 2, 4, and 5, molded part 12 includes bosses 20 and pressure dam 88 (which can also be referred to as a seal 88) molded into B-surface 16 of part 12. FIGS. 4 and 5 thus show that Nitrogen is introduced into mold 26 from pressure supply arrangement 22. The Nitrogen then flows through pin plate 96 and is sealed by O-ring 90 under pin plate 96. The Nitrogen then flows along the pin clearance 98 and pressurizes bosses 20 causing them to move toward show-surface 14 of part 12. As part 12 continues to cure, the depressions 30 (sink marks 30) created by the shrinking of bosses 20 are gradually forced toward show-surface 14 of part 12 (that it, toward second half 84 of mold 26). This allows part 12 to take a permanent set and removes the depressions 30 (sink marks 30) from show-surface 14. FIG. 5 shows sink marks 30 in broken lines, which signify that sink marks 30 were formed during the molding process but were forced out by the end of the molding process.

FIG. 6 shows pin 92 in injection orifice 94 and in a blind hole of boss 20; FIG. 6 shows the detail view shown in broken lines in FIG. 5 relative to the left-most pin 92 and boss 20 in FIG. 5. Nitrogen is shown traveling in the direction of arrow 38 in the gap/clearance 98 between pin 92 and injection orifice 94 (orifice 94 being formed by a bore of first half 82). Nitrogen pressure can thus flow downward into the blind hole of boss 20, around the exterior of boss 20, and to pressure dam 88.

The POP RIM process of the present invention includes the steps of injecting liquid mixture 74 into the mold cavity 28, curing the liquid mixture 74, and pressurizing the curing part 12 using the pressure supply arrangement 22 and pin plate assembly 36 to reduce, eliminate, or prevent sink marks 30 from being formed on the show-surface 14 of molded part 12. In general, the POP RIM process according to the present invention includes receiving liquid mixture 74 in the container/mixer 76. Additionally, the POP RIM process according to the present invention includes an injection cycle, a curing cycle, a pressurization cycle, and a demolding cycle. The injection cycle includes injecting liquid mixture 74 from mixer 26 into mold cavity 28 of mold 26. The curing cycle includes solidifying the mixture 74 into a thermoset plastic; stated another way, the curing cycle can include the thermoset resin cross-linking and polymerizing so as to form poly-DCPD, for example. As more fully explained below, the pressurization cycle includes applying pressure to B-surface 16 of the partially cured thermoset resin to reduce, eliminate, or prevent sink marks from being formed on A-surface 14 of part 12. The demolding cycle includes removing the cured, molded polymer part 12 from mold cavity 28 of mold 26.

More specifically, during the curing cycle Nitrogen under pressure is introduced into mold cavity 28 directly opposite the feature to be affected (i.e., on bosses 20 formed on B-surface 16 opposite the A-surface 14 where sink marks 30 are likely to occur absent pressure on B-surface 16). This is controlled by a series of high pressure valves (as discussed above, for example, valves 42 and 44) set up with timers to allow the pressure to build over time. The amount of pressure and the type of pressure (i.e., mechanical pressure, fluid pressure) depends at least in part on the type of material used to form the molded part 12 and also on the design (the configuration) of the molded part 12. For instance, in the example discussed herein, pressure can be applied to mold cavity 28 of mold 26 and thus to the forming part 12 at varying degrees over time (i.e., continuously or in stages) until the pressure reaches approximately 2000 psig using the POP RIM system 10 shown in the drawings.

At the same time that the injection cycle is initiated (that is, the injection of the liquid mixture 74 the thermoset resin, for example from mixer 76 to mold cavity 28 of mold 26), a delay timer can be activated so that the thermoset resin reaches a partially cured (partially polymerized and partially solidified) state. For example, a 55 second delay timer can be activated so that a 55 second delay exists between the moment that liquid mixture 74 (the thermoset resin) of RIM arrangement 24 is injected into mold cavity 28 of mold 26 and the moment that the Nitrogen gas of pressure supply arrangement 22 is injected into mold cavity 28. This delay timer can be initiated by a signal from controller 106 to controller 52, this signal beginning the time and pressure activities of controller 52.

Pursuant to the example under consideration, as part 12 begins to cure, the Nitrogen pressure begins to build starting at Stage 1 through Stage 6 as follows:

Stage 1—50 psig for 10 seconds,

Stage 2—100 psig for 10 seconds,

Stage 3—300 psig for 10 seconds,

Stage 4—500 psig for 10 seconds,

Stage 5—800 psig for 5 seconds,

Stage 6—1000 psig for 5 seconds.

These stages are but one embodiment of the method according to the present invention. Depending upon the material used to form molded part 12 and the design/configuration of molded part, a different number of stages, different pressures, and different times could be employed.

To successfully use pressure to eliminate sink marks while using thermoset resins with the RIM process, there are at least two problems that must be overcome. First, low resin viscosity creates a problem because the resin (the bi-component mixture 74 mentioned above) will tend to flow into very small crevices, making it critical to design a pressure supply arrangement (i.e., arrangement 22) that will prevent resin from plugging the injection point (i.e., injection orifice 94) of the Nitrogen, for example, into the mold cavity 28 while providing adequate flow during the pressurization cycle. Second, an obstacle results from the adiabatic nature of thermoset resins; during the curing cycle, the rate of change from a liquid to a solid is ever increasing, making it difficult to apply enough pressure to obtain the desired A-surface 14 appearance without injecting gas into the resin (the bi-component mixture 74).

Regarding the first problem, to overcome the issue caused by low material viscosity, a specially designed pressure supply arrangement 22, which can be in the form of a gas injection system, is provided by the present invention. Pressure supply arrangement 22 is one embodiment according to the present invention. The gas injection system of the present invention uses very tight tolerances to achieve the required objective. An injection orifice 94 (for injecting the gas—i.e., Nitrogen—into mold cavity 28) of approximately 0.0005 inches allows minimal resin (the bi-component mixture 74) incursion while the shape of the orifice 94 (annular and circular, for example) allows the small amount of resin to be pushed-out of injection orifice 94 during the pressurization cycle. The present invention disposes of the first problem.

Regarding the second problem, to work successfully with the adiabatic curing phase, the pressure supply arrangement 22 must allow precise control of pressure level as a function of time. Pressure cannot be applied until after the resin has polymerized sufficiently to prevent inclusion of gases in the curing resin; yet, pressure must be applied at sufficient levels to yield the desired results. Control system 22 (another name for pressure supply arrangement 22) provides a low flow supply of inert gas (i.e., Nitrogen) at pressures ranging, for example, from 0 psig to 4500 psig. POP RIM system 10 discussed above includes one embodiment of such a control system 22 according to the present invention. A special valving arrangement is integral to the pressure supply arrangement 22 and, more generally, to the POP RIM system 10 to allow very fast response times while minimizing the tendency of the controlled variable (pressure) to overshoot the set-point pressure (the desired pressure). Pressure supply arrangement 22 includes one embodiment of such a special valving arrangement according to the present invention. The present invention disposes of the second problem.

In use, the operator of system 10 can fill holding tanks 78, 80, for example, with the A and B parts referenced above. Further, controller 52 can include Screens 1 and 2 for the operator. Screen 1 is where the value of the delay time for system start is entered (the delay between injection of mixture 74 into mold cavity 28 and injection of Nitrogen into mold cavity 28 adjacent B-surface 16 of the forming part, the injection of the Nitrogen into mold cavity 28 following the injection of mixture 74 into mold cavity 28). Screen 2 is where up to six sets of parameters (the parameters being the desired time and pressure for each stage) can be entered and where the time value is displayed and whether the respective stage of time and pressure is complete. Each set of parameters of pressure and time is a single stage (all six stages may not be used, depending upon the material of the mixture and the final design/configuration of part 12); in other words, the operator sets pressure and time for each stage. The material used for the bi-component mixture 74 and the design/configuration of the final part 12 are factors used to determine the values of time and pressure and the number of stages to be used. Controller 52 thus has settings for pressure setting and controls actual pressure vales based on those settings. The POP RIM cycle (the method according to the present invention) starts with closing mold 26. Then, the bi-component material mixture 74 is injected into mold cavity 28. The closing of mold 26 and/or the injection of mixture 74 into mold cavity 28 can be what initiates the trigger to pressure supply arrangement 22 (which can also be called “the POP RIM”), thereby starting the delay timer on Screen 1. Stated another way, the closing of mold 26 and/or the injection of mixture 74 into mold cavity 28 can be what starts the delay timer which accounts for the time delay between the injection of mixture 74 into mold cavity 28 and the injection of Nitrogen into mold cavity 28. The signal corresponding to the closing of mold 26 and/or the injection of mixture 74 into mold cavity 28 can be sent from controller 106 to controller 52. Thus, the operator can press a button, for instance, associated with controller 106 and thus the RIM arrangement 24 to start the process for forming part 12. Nitrogen tank 40 (which stores Nitrogen at 2,200 psig) can be hooked to gas line 54 of pressure supply arrangement 22 through a normal two-stage high pressure bottle valve and gauge set, this gauge being set at 2,200 psig (this valve and gauge set are not separately shown in FIG. 1). Nitrogen pressure in mold cavity 28 can be controlled by controller 52 or by turning down pressure on the pressure regulator (i.e., the aforementioned bottle valve and gauge set) of tank 40. When the aforementioned delay timer times out, inlet valve 42 (powered by first solenoid valve 46) starts to oscillate (or, stated another way, pulse) open and closed until the pressure from pressure sensor 50 equals the input on the first stage; if the pressure drops below the set-point, inlet valve 42 will again cycle on until the preset pressure is achieved (the pressure can drop undesirably as a result of imperfect seals at pipe fittings, seal 88, and the like). The oscillation of inlet valve 42 refers to the turning on and off and on and off of inlet valve 42. In one embodiment of the present invention, inlet valve 42 can oscillate on for 5 milliseconds and then off for 5 milliseconds, and then on for 5 milliseconds, and then off for 5 milliseconds, and so forth, until enough Nitrogen pressure is in mold cavity to reach the pressure set-point of the respective stage. This oscillation for such short periods of time helps to precisely control the amount of Nitrogen input into mold cavity and thus to help prevent overshooting the pressure set-point. Thus, inlet valve 42 oscillates in this manner as Nitrogen pressure is raised to the set-point pressure in mold cavity 28. Once the pressure set-point is achieved, the pressure in mold cavity 28 can be held for whatever time the Screen 2 recipe requires; to the extent that Nitrogen pressure undesirably reduces (i.e., via imperfect seals, as indicated above), then controller 52 can again open inlet valve 52 in an oscillating manner to raise the pressure back to the set-point pressure until the time for the respective stage is completed. A closed loop can exist between sensor 50 and inlet valve 42. If a second stage is programmed into controller 52, then inlet valve 42 again oscillates until the Nitrogen pressure is raised to the next pressure set-point. If the Nitrogen pressure set-point is overshot at any time, then dump valve 44 can be activated. When the time value equals the time variable set on Screen 2, Stage 1 is complete; at this time, the next stage is performed the same as described relative to Stage 1. If no values are entered in subsequent stages, the time values are all met and then system 10 will vent the Nitrogen pressure through dump valve 44 (which can also be referred to as vent valve 44, which is powered by second solenoid valve 48). Thus, the oscillation of inlet valve 42 is necessary so as not to overshoot the pressure set-point. The set-point pressure values are set so as not to overpower the mold material 74 (the bi-component mixture 74) or seal 88 forming in the V-groove of first half 82 of mold 26.

Further, as shown in FIGS. 1-5, Nitrogen 34 flows through line 54 of pressure supply arrangement 22 to mold 26. The Nitrogen flows through member 104, through a hole in pin plate 96, and to pins 92. Seal 90 reduces or prevents Nitrogen 34 from flowing out from between the gap formed by plate 96 and mold 26. Nitrogen then flows along each pin 92 to corresponding bosses 20 so as to pressurize bosses 20 (generally in a downward direction according to FIG. 5), causing bosses 20 to move toward the A-surface 14 (the show-surface 14) of part 12. More specifically, Nitrogen 34 flows in the gap formed between the outer diameter of each pin 92 (that is, the circumferential surface of each pin 92) and mold 26 (such as the surface of the mold bores receiving pins 92). Pressure seal 88 molded into part 12 serves to reduce or prevent Nitrogen 34 from escaping to the outer extremities of part 12 and thereby allows the pressure to build in a localized area relative to part 12, the outer extremities of part 12 being those portions of part 12 on the other side of seal 88 relative to bosses 20. As part 12 continues to cure in mold 26, the depressions 30 created by the shrinking of the bosses 20 are gradually forced toward the show-surface 14 side of mold cavity 26; this allows part 12 to take a permanent set and reduces or removes the depressions 30 from the show-surface. Accordingly, system 10 and the method of the present invention minimize, reduce, eliminate, or prevent sink marks on the show-surface 14 of part 12.

The present invention further provides a method for molding part 12 including first surface 14 and second surface 16 opposing first surface 14, the method including the steps of: providing pressure supply arrangement 22 and Reaction Injection Molding (RIM) arrangement 24 including pin plate assembly 36 and mold 26 defining mold cavity 28, pin plate assembly 36 coupled with pressure supply arrangement 22 and mold 26; supplying bi-component liquid mixture 74 to mold cavity 28 using RIM arrangement 24; reacting chemically said bi-component liquid mixture 74 and thereby forming a thermoset polymer 12; and supplying, using pressure supply arrangement 22, an inert gas 34 to mold cavity 28 via pin plate assembly 36 and thereby reducing or eliminating a formation of a sink mark 30 on first surface 14 of part 12. The inert gas 34 can be Nitrogen. Pressure supply arrangement 22 supplies Nitrogen to mold cavity 28 via pin plate assembly 36 under an increasing pressure until part 12 is formed. Pressure supply arrangement 22 includes controller 52, inlet valve 42, first solenoid valve 46 operatively associated with inlet valve 42, dump valve 44, second solenoid valve 48 operatively associated with dump valve 44, and pressure sensor 50, controller 52 being operatively coupled with first solenoid valve 46, second solenoid valve 48, pressure sensor 50, and RIM arrangement 24. Pressure supply arrangement 22 includes first gas line 54 and second gas line 56 intersecting first gas line 54 to form intersection 58, inlet valve 42 and dump valve 44 being in fluid communication with one another, pin plate assembly 36, and mold cavity 28, inlet valve 42 and sensor 50 being connected to first gas line 54, dump valve 44 being connected to second gas line 46, inlet valve 42 being positioned upstream from intersection 58, sensor 50 being positioned downstream from inlet valve 42, intersection 58, and dump valve 44. Sensor 50 determines an actual pressure in first gas line 54, controller 52 receiving the actual pressure, comparing the actual pressure to at least one set-point pressure, and selectively influencing inlet valve 42 and dump valve 44 dependent on the actual pressure so that Nitrogen is supplied to mold cavity in accordance with the at least one set-point pressure. Pin plate assembly 36 includes at least one pin 92, mold 26 including a first half 82 and a second half 84, first half 82 including an injection orifice 94 in which the at least one pin 92 runs therethrough, injection orifice 94 and at least one pin 92 forming an annular clearance 98 therebetween of 0.0005 inches which injects Nitrogen into mold cavity 28. Injection orifice 94 and at least one pin 92 form annular clearance 98 and thereby together allow any incursion of bi-component liquid mixture 74 into annular clearance 98 to be pushed out of annular clearance 98 when Nitrogen 34 is injected into mold cavity 28 via annular clearance 98.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for molding a part including a first surface and a second surface opposing the first surface, said system comprising:
a pressure supply arrangement; and
a Reaction Injection Molding (RIM) arrangement including a pin plate assembly and a mold defining a mold cavity, said RIM arrangement configured for supplying a bi-component liquid mixture to said mold cavity in which said bi-component liquid mixture chemically reacts and thereby forms a thermoset polymer, said pin plate assembly coupled with said pressure supply arrangement and said mold, said pressure supply arrangement configured for supplying an inert gas to said mold cavity via said pin plate assembly and thereby for one of reducing and eliminating a formation of a sink mark on the first surface of the part.

2. The system of claim 1, wherein said inert gas is Nitrogen.

3. The system of claim 2, wherein said pressure supply arrangement is configured for supplying said Nitrogen to said mold cavity via said pin plate assembly under an increasing pressure until the part is formed.

4. The system of claim 3, wherein said pressure supply arrangement includes a controller, an inlet valve, a first solenoid valve operatively associated with said inlet valve, a dump valve, a second solenoid valve operatively associated with said dump valve, and a pressure sensor, said controller being operatively coupled with said first solenoid valve, said second solenoid valve, said pressure sensor, and said RIM arrangement.

5. The system of claim 4, wherein said pressure supply arrangement includes a first gas line and a second gas line intersecting said first gas line to form an intersection, said inlet valve and said dump valve being in fluid communication with one another, said pin plate assembly, and said mold cavity, said inlet valve and said sensor being connected to said first gas line, said dump valve being connected to said second gas line, said inlet valve being positioned upstream from said intersection, said sensor being positioned downstream from said inlet valve, said intersection, and said dump valve.

6. The system of claim 5, wherein said sensor is configured for determining an actual pressure in said first gas line, said controller being configured for receiving said actual pressure, for comparing said actual pressure to at least one set-point pressure, and for selectively influencing said inlet valve and said dump valve dependent on said actual pressure so that said Nitrogen is supplied to said mold cavity in accordance with said at least one set-point pressure.

7. The system of claim 6, wherein said pin plate assembly includes at least one pin, said mold including a first half and a second half, said first half including an injection orifice in which said at least one pin runs therethrough, said injection orifice and said at least one pin forming an annular clearance therebetween of 0.0005 inches which is configured for injecting said Nitrogen into said mold cavity.

8. The system of claim 7, wherein said injection orifice and said at least one pin form said annular clearance and thereby together are configured for allowing any incursion of said bi-component liquid mixture into said annular clearance to be pushed out of said annular clearance when said Nitrogen is injected into said mold cavity via said annular clearance.

9. A method for molding a part including a first surface and a second surface opposing the first surface, said method comprising the steps of:
providing a pressure supply arrangement and a Reaction Injection Molding (RIM) arrangement including a pin plate assembly and a mold defining a mold cavity, said pin plate assembly coupled with said pressure supply arrangement and said mold;
supplying a bi-component liquid mixture to said mold cavity using said RIM arrangement;
reacting chemically said bi-component liquid mixture and thereby forming a thermoset polymer; and
supplying, using said pressure supply arrangement, an inert gas to said mold cavity via said pin plate assembly and thereby one of reducing and eliminating a formation of a sink mark on the first surface of the part.

10. The method of claim 9, wherein said inert gas is Nitrogen.

11. The method of claim 10, wherein said pressure supply arrangement supplies said Nitrogen to said mold cavity via said pin plate assembly under an increasing pressure until the part is formed.

12. The method of claim 11, wherein said pressure supply arrangement includes a controller, an inlet valve, a first solenoid valve operatively associated with said pilot valve, a dump valve, a second solenoid valve operatively associated with said dump valve, and a pressure sensor, said controller being operatively coupled with said first solenoid valve, said second solenoid valve, said pressure sensor, and said RIM arrangement.

13. The method of claim 12, wherein said pressure supply arrangement includes a first gas line and a second gas line intersecting said first gas line to form an intersection, said inlet valve and said dump valve being in fluid communication with one another, said pin plate assembly, and said mold cavity, said inlet valve and said sensor being connected to said first gas line, said dump valve being connected to said second gas line, said inlet valve being positioned upstream from said intersection, said sensor being positioned downstream from said inlet valve, said intersection, and said dump valve.

14. The method of claim 13, wherein said sensor determines an actual pressure in said first gas line, said controller receiving said actual pressure, comparing said actual pressure to at least one set-point pressure, and selectively influencing said inlet valve and said dump valve dependent on said actual pressure so that said Nitrogen is supplied to said mold cavity in accordance with said at least one set-point pressure.

15. The method of claim 14, wherein said pin plate assembly includes at least one pin, said mold including a first half and a second half, said first half including an injection orifice in which said at least one pin runs therethrough, said injection orifice and said at least one pin forming an annular clearance therebetween of 0.0005 inches which injects said inert gas into said mold cavity.

16. The method of claim 15, wherein said injection orifice and said at least one pin form said annular clearance and thereby together allow any incursion of said bi-component liquid mixture into said annular clearance to be pushed out of said annular clearance when said inert gas is injected into said mold cavity via said annular clearance.
